(19) United States
(12) Patent Application Publication
(10) Pub. No.: US 2002/0169626 A1
(43) Pub. Date: Nov. 14, 2002

(54) Method and apparatus for providing a reference

(76) Inventors: Jay S. Walker, Ridgefield, CT (US); Scott B. Allison, Stamford, CT (US); Pranaya Chulet, New York, NY (US); Vikas Kapoor, New York, NY (US); Timothy A. Palmer, New York, NY (US)

Correspondence Address: WALKER DIGITAL, FIVE HIGH RIDGE PARK, STAMFORD, CT, 06905, US

(21) Appl. No.: 09/901,787

(22) Filed: Jul. 9, 2001

Related U.S. Application Data
(60) Provisional application No. 60/216,884, filed on Jul. 7, 2000.

(51) Int. Cl. G06F 17/60

(52) U.S. Cl. 705/1

(57) ABSTRACT

Systems and methods are provided for providing a reference for a prospective customer. In one embodiment, a method of the invention involves receiving one or more criteria from the prospective customer regarding a potential purchase, providing merchant information for at least one merchant in response to the one or more criteria, providing at least one reference provider for the at least one merchant, and enabling communication between the prospective customer and the at least one reference provider.

### CROSS-REFERENCE TO RELATED APPLICATIONS

This application claims the benefit of provisional U.S. patent application Ser. No. 60/216,884, filed Jul. 7, 2000, for “Anonymous Communication for References”, the content of which is incorporated by reference herein for all purposes.

### FIELD

This invention relates generally to a method and apparatus for providing to a prospective customer a reference for a merchant. More particularly, this invention relates to a method and apparatus for enabling a prospective customer to ascertain information about a merchant through communication with one or more references of the merchant.

### BACKGROUND

It is often difficult for a prospective customer to find a good merchant, particularly a good service provider. Traditional techniques for finding a merchant, such as searching in the Yellow Pages or asking friends for references, have drawbacks.

Although a prospective customer may be able to find a merchant using the Yellow Pages or a referral service, neither the Yellow Pages nor other directories of merchants provide either an objective measure, a detailed measure, or a third party assessment of the quality of a merchant. A friend may be able to recommend and provide some feedback for some merchants regarding the quality of their goods or services; however, the friend will frequently be unable to provide such feedback for a particular merchant of interest to the prospective customer. Further, a friend will frequently be unable to recommend merchants for the particular goods or services of interest to the prospective customer.

A number of problems currently exist with the use of reference providers by prospective customers. One problem is that it is often difficult, if not impossible, to find a reference provider. Another problem is that the prospective customer may have to contact a merchant, ask for reference providers for the merchant, and then provide some basic information to the merchant, such as name and contact information, in order to receive references. Another problem is that merchants may be reluctant to provide the identities of reference providers. Further, past customers of a merchant may not want to be bothered by prospective customers, making it difficult to find reference providers.

### SUMMARY

In one embodiment, the invention is a method for providing a reference for a prospective customer. In this embodiment, the method comprises receiving one or more criteria from the prospective customer regarding a potential purchase, providing merchant information for at least one merchant in response to the one or more criteria, providing at least one reference provider for the at least one merchant, and enabling communication between the prospective customer and the at least one reference provider.

### BRIEF DESCRIPTION OF THE DRAWINGS

FIG. 1 is a flow diagram illustrating an exemplary process according to an embodiment of the invention.

FIG. 2 is a block diagram of a system consistent with the present invention and operable with the process of FIG. 1.

FIG. 3 is a block diagram of one embodiment of the controller depicted in FIG. 2.

FIG. 4 is a table illustrating an exemplary data structure of the merchant database of FIG. 3.

FIG. 5 is a table illustrating an exemplary data structure of the reference provider database of FIG. 3.

FIG. 6A is a table illustrating an exemplary data structure of the reference database of FIG. 3.

FIG. 6B is a continuation of the table of FIG. 6A.

FIG. 7 is a table illustrating an exemplary data structure of the prospective customer database of FIG. 3.

FIG. 8 is a table illustrating an exemplary data structure of the contact database of FIG. 3.

FIG. 9 is a flow diagram illustrating an exemplary process according to an embodiment of the invention.

FIG. 10 is a flow diagram illustrating an exemplary process for registering a merchant in accordance with the process of FIG. 9.

FIG. 11 is a flow diagram illustrating an exemplary process for registering a reference provider in accordance with the process of FIG. 9.

FIG. 12 is a flow diagram illustrating an exemplary process for searching for a merchant in accordance with the process of FIG. 9.

FIG. 13 is a flow diagram illustrating an exemplary process for allowing a reference provider to control communication with prospective customers according to an embodiment of the invention.

FIG. 14A is a flow diagram illustrating an exemplary process for allowing a merchant to control communication between reference providers and prospective customers according to an embodiment of the invention.

FIG. 14B is a flow diagram illustrating an exemplary process for providing a merchant with control over communication between reference providers and prospective customers according to an embodiment of the invention.

FIG. 15 is a flow diagram illustrating an exemplary process facilitating communication between a reference provider and a merchant according to an embodiment of the invention.

### DETAILED DESCRIPTION

The methods and devices of the invention allow prospective customers to find a merchant and receive a reference from a reference provider who has used the merchant in the past. A prospective customer may thus benefit from receiving a reference for a merchant from a reference provider who has actually used the merchant.

Throughout this specification, the term “merchant” will be used to refer to a seller of any product or service, and is therefore intended to include, but not be limited to, a service provider. The term “prospective customer” will be used to refer to a customer who is considering using a merchant for a service or for the purchase of a product. The term “reference” will be used to refer to a testimonial, rating, or assessment as to the merits of a merchant, whether static or interactive, and whether text, audio, visual, or any other form. The term “reference provider” will be used to refer to the individual or entity that provides a reference. References may be used by service providers, such as physicians, electricians, and the like, and by sellers of all types of goods, including goods such as vehicles that may have warranties for service. The embodiments of the invention, therefore, may be used for merchants of goods and services. The “potential purchase” of the prospective customer, therefore, may be a good and/or service or, in other embodiments, a query that may be used to find the good and/or service that the prospective customer wishes to purchase.

Various embodiments of the present invention allow a prospective customer to search for a merchant and then receive a reference for that particular merchant, thus permitting the prospective customer to make a judgment as to the quality of the merchant before transacting with the merchant. According to some embodiments, communication is enabled between a reference provider and the prospective customer. In other embodiments of the invention, communication between the reference provider and the prospective customer is not facilitated. Instead, the prospective customer can access a testimonial from the reference provider in order to obtain a reference for a merchant.

Another embodiment of the invention is a device, such as a computer, having a processor and a storage device coupled to the processor and storing instructions adapted to be executed by the processor to carry out one or more of the processes described below. Still another embodiment of the invention is a medium, such as a floppy or compact disk, storing instructions adapted to be executed by a processor to perform the method for providing a reference outlined below.

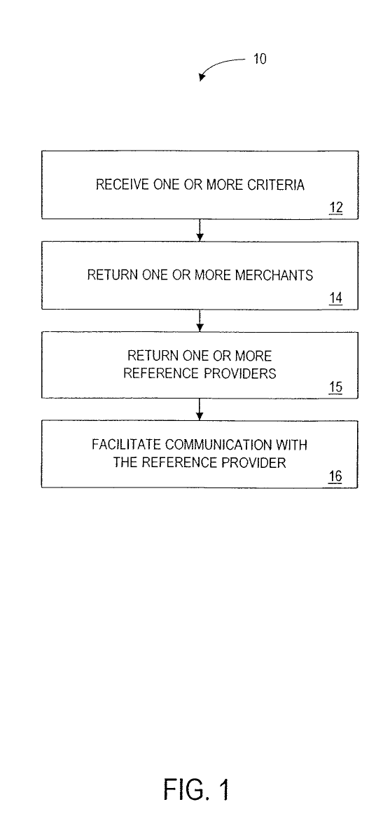

FIG. 1 is a flow diagram illustrating an exemplary process 10 for providing a reference for a prospective customer according to an embodiment of the invention. In the embodiment of FIG. 1, the process 10 includes receiving one or more criteria from a prospective customer regarding a potential purchase (step 12), providing merchant information for at least one merchant in response to the one or more criteria (step 14), providing one or more reference providers for the at least one merchant (step 15), and facilitating communication between the prospective customer and a reference provider for the at least one merchant (step 16). The exemplary process depicted in FIG. 1 will be discussed in greater detail in the following sections.

In accordance with the process of FIG. 1, a prospective customer can search for merchants that perform certain services and then receive a reference from a reference provider for a particular merchant. For example, a prospective customer may wish to locate a plumber for residential buildings in the Chicago area. In an Internet embodiment, the prospective customer could enter search criteria, such as “Chicago plumber,” into a search field on a Web page and then receive a list of plumbers that perform plumbing services in the Chicago area. Search fields could be set up to provide geographical search fields and goods or services search fields. The prospective customer could use a computer in a convenient location, such as the prospective customer's home or business, and access via the Internet and World Wide Web a central server that contains merchant information. After a list of plumbers is presented to the prospective customer, the prospective customer could select a particular plumber and view more detailed information about the plumber and/or view reference providers who will provide a reference for the plumber. The prospective customer may then request to communicate with a particular reference provider by telephone, e-mail, or instant messaging, and a central server could facilitate the communication between the prospective customer and the reference provider. The prospective customer could then ask the reference provider detailed questions about the quality of the plumber, such as whether the plumber performed plumbing work in a timely manner for a reasonable price.

In other embodiments, the prospective customer could view or listen to written testimonials about the merchant from a reference provider. In another embodiment, the prospective customer could access the central server with a conventional or cellular telephone and enter search criteria by speaking or by following prompts to use the telephone keypad. According to some embodiments, an interactive voice response system and/or touchpad response system could prompt the prospective customer and provide audio feedback regarding merchants and reference providers for the merchants.

### a. Hardware for an Embodiment of the Invention

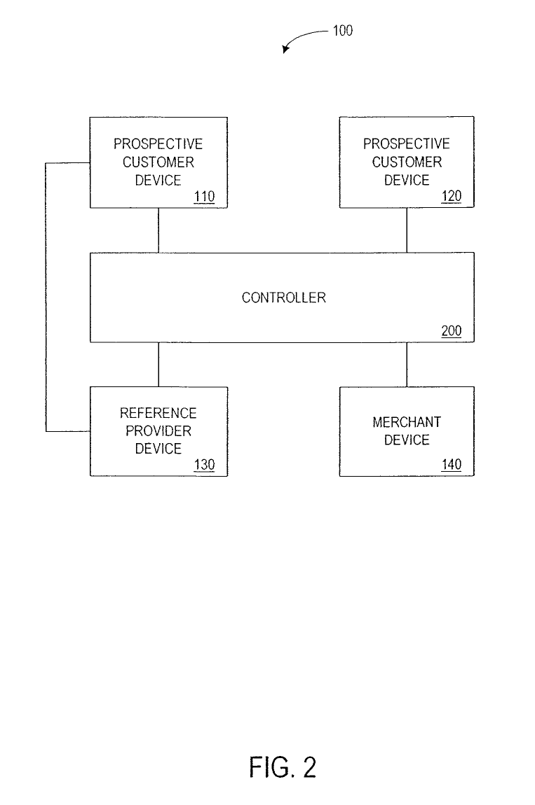

Referring now to FIG. 2, an apparatus 100 according to an embodiment of the present invention includes a controller 200 that is in communication with one or more prospective customer devices 110, 120, one or more reference provider devices 130, and one or more merchant devices 140. The controller 200 may communicate with the prospective customer devices 110, 120, reference provider devices 130, and merchant devices 140 directly or via a network such as the Internet or World Wide Web. Each of the prospective customer devices 110, 120, reference provider devices 130, and merchant devices 140 may comprise computers, such as those based on the Intel® Pentium® processor, that are adapted to communicate with the controller 200 over a communication network. Any number of prospective customer devices 110, 120, reference provider devices 130, and/or merchant devices 140 may be in communication with the controller 200. Any or all of the devices 110, 120, 130, 140 may be, e.g., conventional personal computers, portable types of computers, such as a laptop computer, a palm-top computer, a hand-held computer, or a Personal Digital Assistant (PDA). In addition, any one or all of the devices may be telephones or telephone systems that may communicate via audio or touch-tone control with the controller 200.

Communication between the prospective customer devices 110, 120, reference provider devices 130, merchant devices 140 and the controller 200 may be direct or indirect, such as over the Internet through a Web site maintained by the controller 200 on a remote server or over an on-line data network including commercial on-line merchants, bulletin board systems and the like. In other embodiments, the devices 110, 120, 130, 140 may be telephones, and a user on the devices 110, 120, 130, 140 may communicate with the controller 200 through an interactive voice response system (“IVR”). In yet other embodiments, the devices 110, 120, 130, 140 may communicate with controller 200 over radio frequency (“RF”), cellular telephone, cable TV, satellite links and the like.

A prospective customer may use a prospective customer device 110, 120 to access the controller 200 to search for merchants and reference providers for the merchants. Similarly, a reference provider may use a reference provider device 130 to communicate with the controller 200 and to communicate with prospective customers via the controller 200. A merchant may use a merchant device 140 to access and communicate with the controller 200 and to monitor references provided by reference providers.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet may not transmit data to the other device for weeks at a time.

The controller 200 may function as a “Web server” that generates Web pages (documents on the Web that typically include an HTML file and associated graphics and script files) that may be accessed via the Web and allows communication with the controller 200 in a manner known in the art.

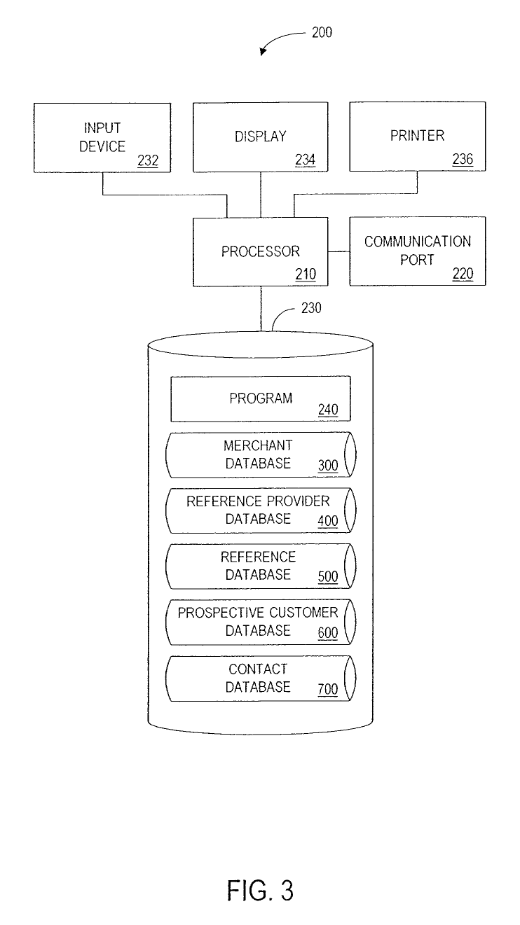

FIG. 3 illustrates an embodiment of the controller 200. The controller 200 may be implemented as a system controller, a dedicated hardware circuit, an appropriately programmed general purpose computer or computers, or any other equivalent electronic, mechanical or electromechanical device.

The controller 200 comprises a processor 210, such as one or more Intel® Pentium® processors. The processor 210 is coupled to a communication device 220 through which the processor 210 communicates with other devices, such as devices 110, 120, 130, 140. The processor 210 is also in communication with a data storage device 230. The data storage device 230 comprises an appropriate combination of magnetic, optical and/or semiconductor memory, and may include, for example, Random Access Memory (RAM), Read-Only Memory (ROM), a compact disc and/or a hard disk. The processor 210 and the storage device 230 may each be, for example: (i) located entirely within a single computer or other computing device; or (ii) connected to each other by a remote communication medium, such as a serial port cable, telephone line or radio frequency transceiver. In one embodiment, the controller 200 may comprise one or more computers that are connected to a remote server computer for maintaining databases, and in an embodiment containing more than one computer as the controller 200, the computers may be run by the same party or by different parties. For instance, an Internet service provider may operate a computer that performs some or all of the functions, and some or all of the functions may also be performed by a third party's computer. The processor 210 may also be connected to one or more input devices 232, such as a keyboard or mouse, and output devices, such as a display 234 and a printer 236.

The data storage device 230 stores a program 240 for controlling the processor 210. The processor 210 performs instructions of the program 240, and thereby operates in accordance with the present invention, and particularly in accordance with the methods described in detail herein. The program 240 may be stored in a compressed, uncompiled and/or encrypted format. The program 240 furthermore includes program elements that may be necessary, such as an operating system, a database management system, and “device drivers” for allowing the processor 210 to interface with computer peripheral devices. Appropriate program elements are known to those skilled in the art, and need not be described in detail herein. Program 240 in FIG. 3 represents a single program or multiple programs, whether the programs are stored in the same storage device or not.

According to an embodiment of the present invention, the instructions of the program 240 may be read into a main memory from another computer-readable medium, such as from a ROM to RAM. Execution of sequences of the instructions in program 240 causes processor 210 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

The storage device 230 also stores one or more databases. In the embodiment of FIG. 3, the storage device 230 contains (i) a merchant database 300, (ii) a reference provider database 400, (iii) a reference database 500, (iv) a prospective customer database 600, and (v) a contact database 700. The databases 300, 400, 500, 600, 700 are described in detail below and depicted with exemplary entries in the accompanying figures. As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases 300, 400, 500, 600, 700 represent exemplary information only; those skilled in the art will understand that the number and content of the entries can be different from those illustrated herein. In addition, not every implementation of the processes 10, 800 of the invention will need to use each of these databases.

### b. Database Structure of an Embodiment of the Invention

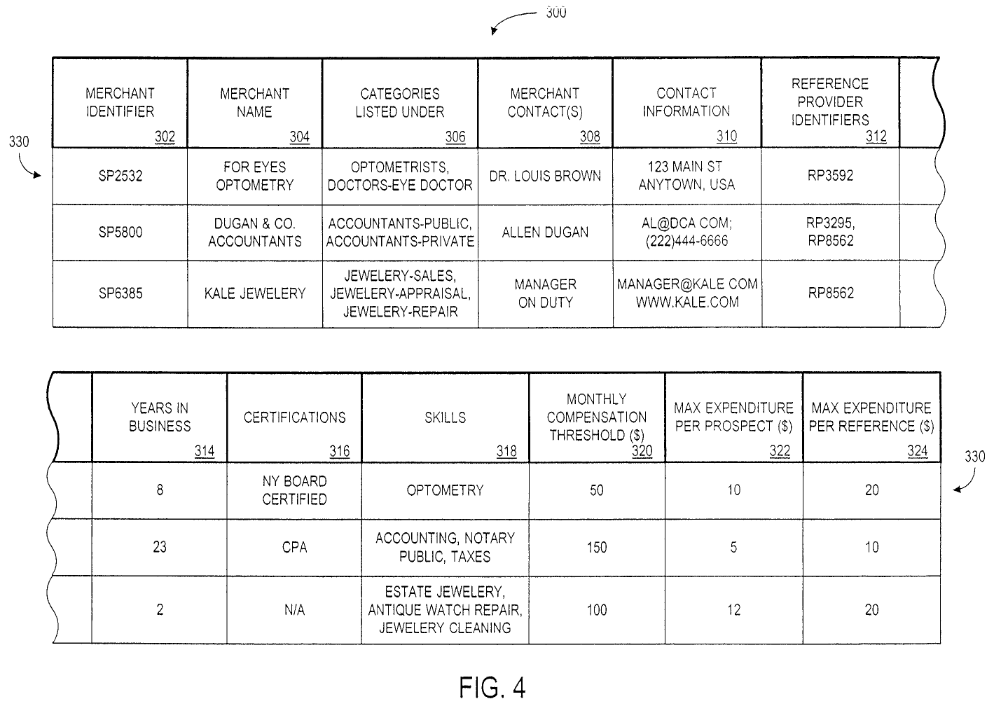

Referring now to FIG. 4, a tabular representation of the merchant database 300 is depicted. The merchant database 300 may be accessed by the processor 210 when a prospective customer searches for merchants. In addition, merchants may access the merchant database 300 in order to register with the system and method of the invention and to control access to reference providers, as discussed in detail below. The tabular representation of the database 300 includes a number of example records or entries each defining a merchant. Those skilled in the art will understand that the database 300 may include any number of entries. The tabular representation of database 300 also defines fields for each of the entries or records. The fields specify: (i) a merchant identifier 302 that uniquely identifies the merchant; (ii) a name of the merchant 304; (iii) a field of categories under which the merchant may be listed 306; (iv) one or more contact names for the merchant 308; (v) contact information 310, such as an address, telephone number, or e-mail address for the merchant; (vi) reference provider identifiers 312 that provide a unique identifier of each reference provider for a merchant; (vii) years the merchant has been in business 314; (viii) certifications 316 of the merchant; (ix) skills of the merchant; (x) maximum monthly compensation threshold 320, which may be a dollar amount per month that the merchant is not willing to exceed in rewarding reference providers in a given month or other time period; (xi) maximum expenditure per prospect 322, which may be a maximum dollar amount that a merchant is willing to spend on a single prospective customer in a given time period; and (xii) a maximum expenditure per reference 324, which may be a maximum dollar amount that a merchant is willing to spend on a single reference in a given time period.

The maximum monthly compensation threshold 320, maximum expenditure per prospect 322, and maximum expenditure per reference 324 are compensation numbers that each merchant can set in order to control expenditures and contacts between reference providers and prospective customers. For example, in the embodiment of FIG. 4, entry 330 defines a maximum monthly compensation threshold 320 for merchant “SP2532” of “$50.” In one embodiment, if the merchant spends $50 in a given month compensating reference providers for references, then no further references may be allowed for the merchant. A maximum expenditure per prospect 322 of $10 is defined for entry 330 in FIG. 4. If merchant SP2432 spends $10 on a single prospect in a given month, therefore, no further references may be allowed for that prospective customer in this embodiment. A maximum expenditure per reference 324 of $20 is defined for entry 330 in FIG. 4. If merchant SP2432 spends $20 compensating a single reference provider in a given month, that reference provider may not be allowed to provide further references in the month. It should be understood that numerous other formats or types of data may be used for the merchant database 300 in accordance with the scope of the invention.

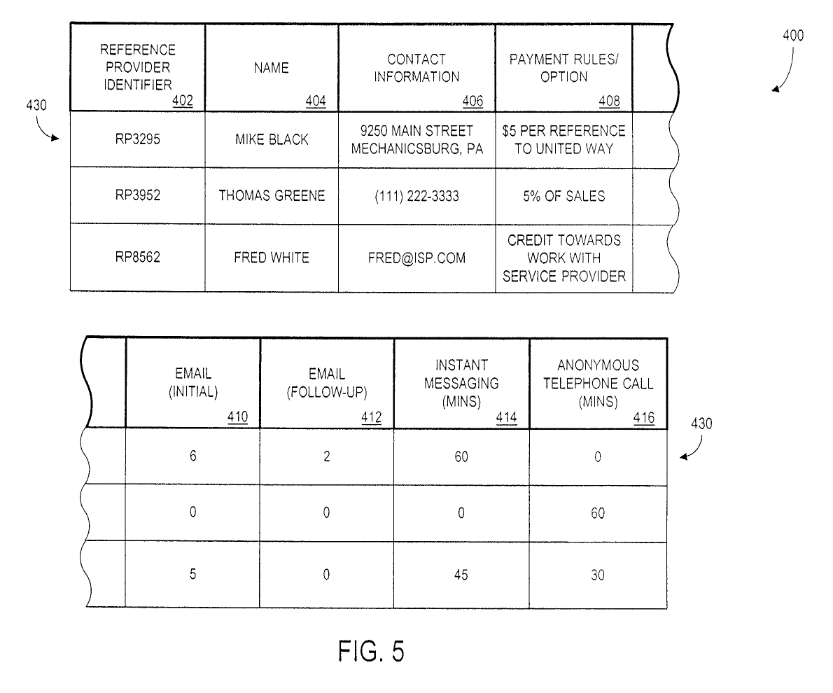

Referring now to FIG. 5, a tabular representation of the reference provider database 400 is depicted. The reference provider database 400 may be accessed when a reference provider registers with the system and method of the invention and when reference providers for merchants are provided to the prospective customer. The tabular representation of the database 400 includes a number of example records or entries each defining a reference provider. Those skilled in the art will understand that the database 400 may include any number of entries, and the content of the entries may vary. The tabular representation of the database 400 also defines fields for each of the entries or records. The fields specify: (i) a reference provider identifier 402 that uniquely identifies each reference provider of the method and system; (ii) the name 404 of the reference provider; (iii) contact information 406 for the reference provider, such as an address, telephone number, or e-mail address; (iv) payment rules and options 408 for the reference provider; (v) a maximum number of initial contacts 410 that may be made by prospective customers each month; (vi) a maximum number of follow-up contacts 412 that may be made by prospective customers each month; (vii) a maximum amount of time per month 414 that the reference provider is willing to spend on instant messaging; and (viii) a maximum amount of time per month 416 that the reference provider is willing to spend on telephone calls.

The term “initial contact” refers to a first, or initial, communication between a reference provider and a prospective customer, whereas a “follow-up contact” refers to any communication between a reference provider and a prospective customer after the initial contact. By controlling the maximum number of initial contacts 410, maximum number of follow-up contacts 412, and maximum amounts of time 414, 416 spent communicating, a reference provider is able to exercise a level of control over communication with prospective customers.

For example, for entry 430 of FIG. 5 for reference provider “RP3295,” the maximum number of initial e-mail contacts 410 is specified as “6.” After “6” unique prospective customers have communicated with the reference provider, therefore, the reference provider may no longer be available for communication. Similarly, after “2” follow-up e-mails with the reference provider (field 412 for entry 430 in FIG. 5), the reference provider may no longer be available for communication. The maximum amount of time 414 that reference provider RP3295 is willing to spend on instant messaging in a given month is “60” minutes, and therefore the reference provider may not be available for instant messaging communication after the reference provider has spent “60” minutes in the month in instant messaging communication. Finally, reference provider RP3295 is not willing to allow telephone communication, and therefore RP3295 may not be available for telephone communication.

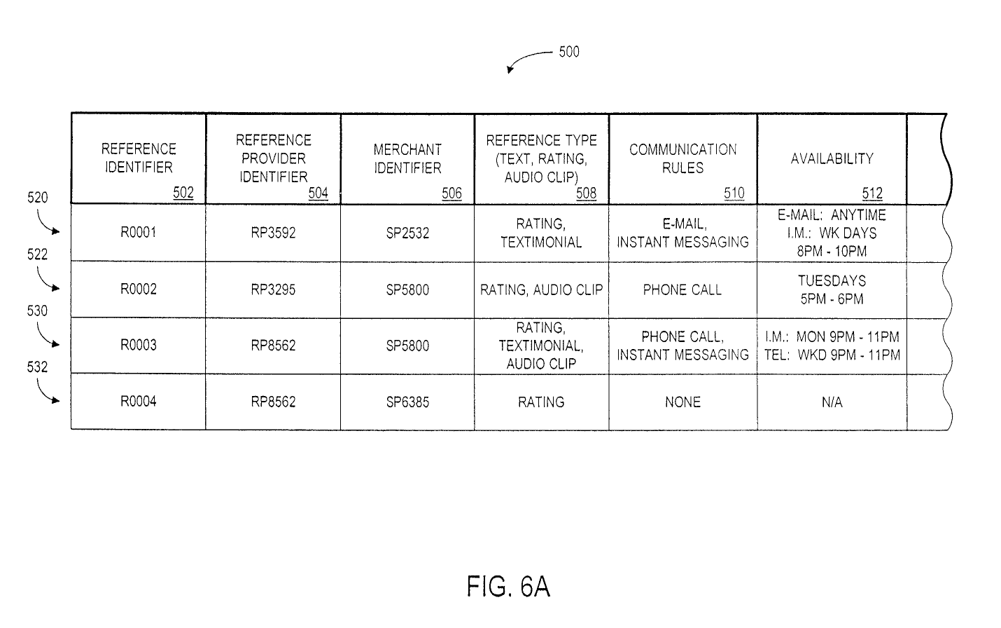

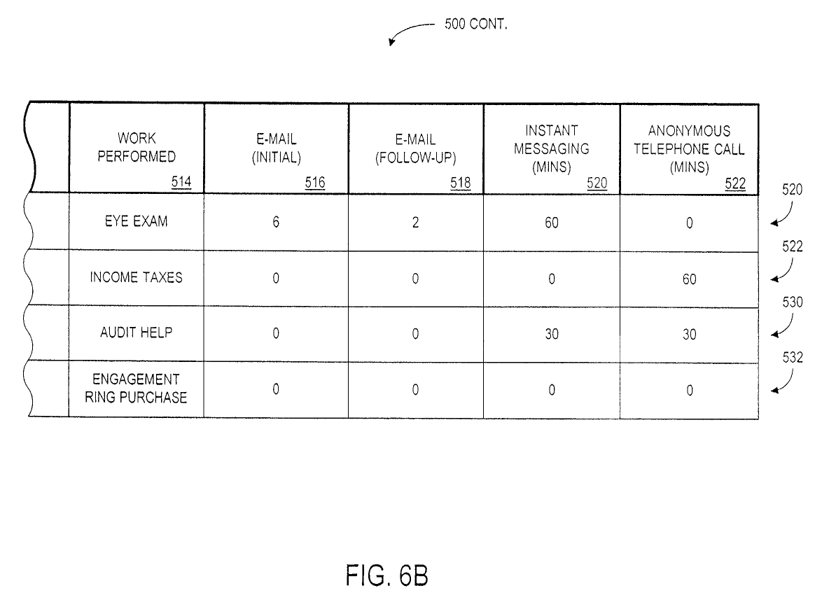

Referring now to FIGS. 6A and 6B, a tabular representation of reference database 500 is depicted. The reference database 500 may be a database of each reference available on the system and method of the invention. The reference database 500 may, in one embodiment, be combined with the reference provider database 400. In the embodiment of FIGS. 5, 6A, and 6B, however, a separate database 500 is provided for references, and the reference database 500 may contain information about the content of a reference. Because a reference provider may provide references for more than one merchant, the reference provider may set up each reference in a different manner, and an entry for each such reference may be kept in the reference database 500. The tabular representation of the database 500 includes a number of example records or entries each defining a particular reference that may be provided by the system and method of the invention. Those skilled in the art will understand that the database 500 may include any number of entries, and the content of the entries may vary. The tabular representation of the database 500 also defines fields for each of the entries or records. The fields specify: (i) a reference identifier 502 that uniquely identifies each reference; (ii) a reference provider identifier 504 that identifies the reference provider for the reference; (iii) a merchant identifier 506 that identifies the merchant for which the reference may be provided; (iv) a reference type 508 that identifies the type of the reference (e.g., audio, testimonial, rating); (v) communication rules for the reference, which specify the type of communication, if any, allowed by the reference provider; (vi) availability 512 of the reference provider; (vii) work performed 514 by the merchant for the reference provider; (viii) a maximum number of initial contacts 516 that may be made by prospective customers each month for the reference; (ix) a maximum number of follow-up contacts 518 that may be made by prospective customers each month for the reference; (x) a maximum amount of time per month 520 that the reference provider is willing to spend on instant messaging; and (xi) a maximum amount of time per month 522 that the reference provider is willing to spend on telephone calls for the reference.

In various embodiments, either the merchant or the reference provider may be able to control fields 516, 518, 520, and 522, such that the merchant or the reference provider may be given a level of control over the references provided. Records 530 and 532 in the reference database 500 are references provided by the same reference provider (RP8562) for different merchants (merchants SP5800 and SP6385). The number of contacts allowed by the reference provider (fields 410, 412) and maximum amounts of time for communication (fields 414, 416) for the reference provider, therefore, have been divided between these two references 530, 532 in fields 516, 518, 520, 522.

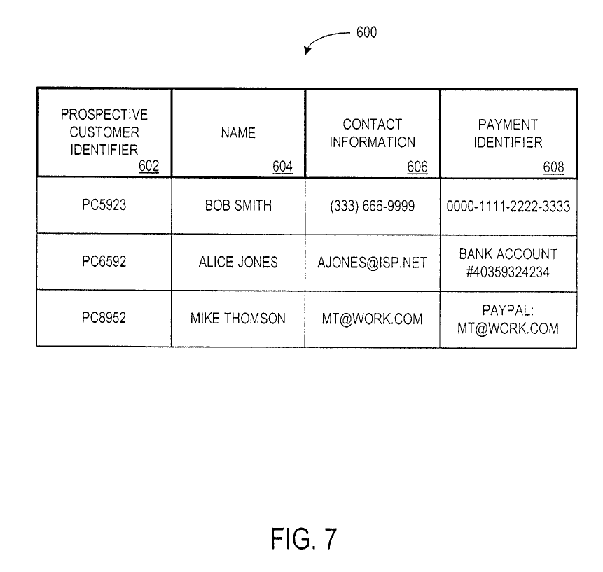

Referring now to FIG. 7, a tabular representation of a prospective customer database 600 is depicted. The prospective customer database 600 may contain information about each prospective customer who uses the system and method of the invention. The prospective customer database 600 may be used for billing of prospective customers in one embodiment and/or for facilitating communication between reference providers and prospective customers via the contact information 606. The tabular representation of the database 600 includes a number of example records or entries each defining a prospective customer. Those skilled in the art will understand that the database 600 may include any number of entries, and the content of the entries may vary. The tabular representation of the database 600 also defines fields for each of the entries or records. The fields specify: (i) a prospective customer identifier 602 that uniquely identifies each prospective customer of the method and system of the invention; (ii) the name 604 of the prospective customer; (iii) contact information 606 for a prospective customer, such as an address, telephone number, or e-mail address; and (iv) a payment identifier 608 for the prospective customer that may be used in embodiments of the invention for which the prospective customer pays to receive a reference.

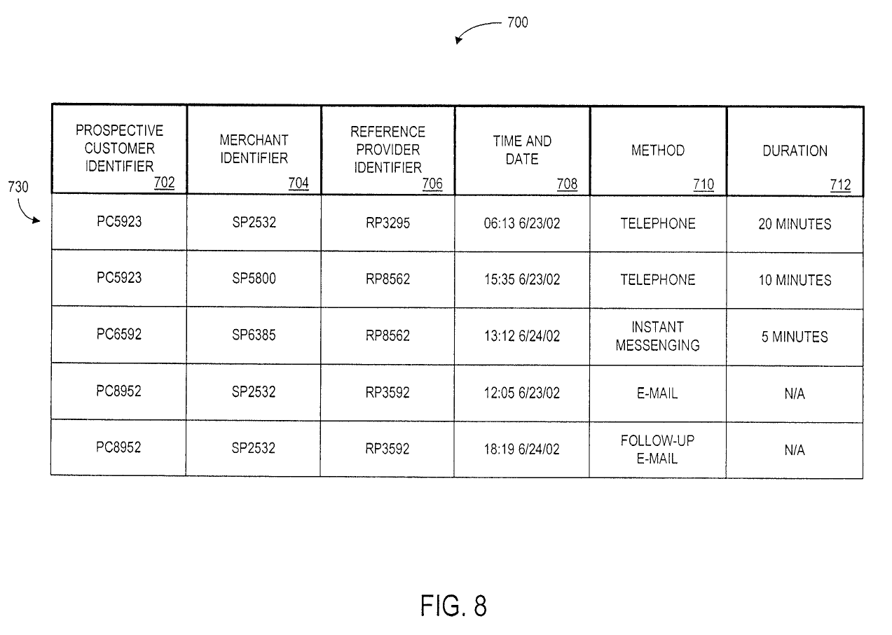

Referring now to FIG. 8, a tabular representation of the contact database 700 is depicted. The contact database 700 may contain a listing of each contact, communication, or reference provided in accordance with embodiments of the invention. The contact database 700 may be used for allowing reference providers or merchants to control references given to prospective customers, as explained below, and for billing purposes. The tabular representation of the database 700 includes a number of example records or entries each defining a contact, reference, or communication provided in accordance with the invention. Those skilled in the art will understand that the database 700 may include any number of entries, and the content of the entries may vary. The tabular representation of the database 700 also defines fields for each of the entries or records. The fields specify: (i) a prospective customer identifier 702 for the contact; (ii) a merchant identifier 704 for the contact; (iii) a reference provider identifier 706 for the contact; (iv) the time and date 708 of the contact; (v) the method 710 of the contact (e.g., telephone, email, static testimonial); and (vi) the duration 712 of the contact if applicable. Record 730 of FIG. 8, for example, indicates that prospective customer PC5923 communicated via telephone for “20” minutes on “June 23” with reference provider RP3295 regarding merchant SP2432.

### c. Providing a Reference for a Prospective Customer

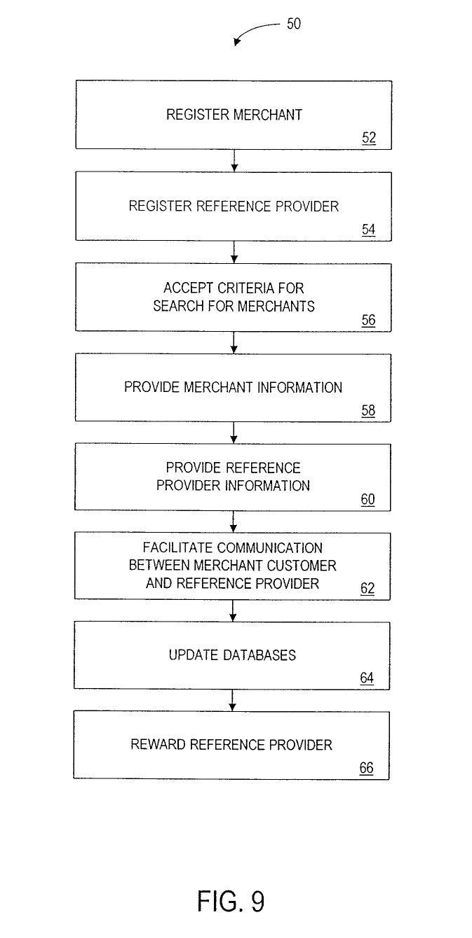

FIG. 9 depicts a detailed embodiment of the invention that may be carried out by the controller 200 and practiced in accordance with the embodiment of FIG. 1. FIG. 9 depicts the acts of FIG. 1 along with several additional acts that may be performed in different embodiments of the invention. FIG. 9 depicts a flow chart 50 of an embodiment of the invention carried out by the controller 200 that begins with registration of merchants (step 52) and reference providers (step 54). Search criteria is accepted by the controller 200 from a prospective customer for a search for merchants (step 56) and merchant information (step 58) and reference provider information (step 60) is provided by the controller 200 to the prospective customer. The controller 200 then facilitates communication between the prospective customer and the reference provider (step 62). The databases of the controller 200 are then updated (step 64) and the reference provider is rewarded (step 66) for providing the reference. The merchant information may include any information related to one or more merchants, such as identification information, contact information, or rating information. The particular arrangement of elements in the flow charts discussed herein is not meant to imply a fixed order to the acts; embodiments of the present invention can be practiced in any order that is practicable.

The individual acts depicted in FIGS. 1 and 9 are described in greater detail in the remainder of this specification, and the following examples are several examples that illustrate additional embodiments of the present invention. These examples do not constitute a definition of all possible embodiments, and those skilled in the art will understand that the present invention is applicable to many other embodiments. Further, although the following examples are briefly described for clarity, those skilled in the art will understand how to make any changes, if necessary, to the above-described apparatus and methods to accommodate these and other embodiments and applications.

### 1. Merchant Registration

In one embodiment of the invention, merchants and reference providers for the merchants may be registered with the controller 200 (FIG. 3) such that some of the information in the merchant database 300 of FIG. 4, reference provider database 400 of FIG. 5, and reference database 500 of FIG. 6 is stored on the data storage device 230 (FIG. 3).

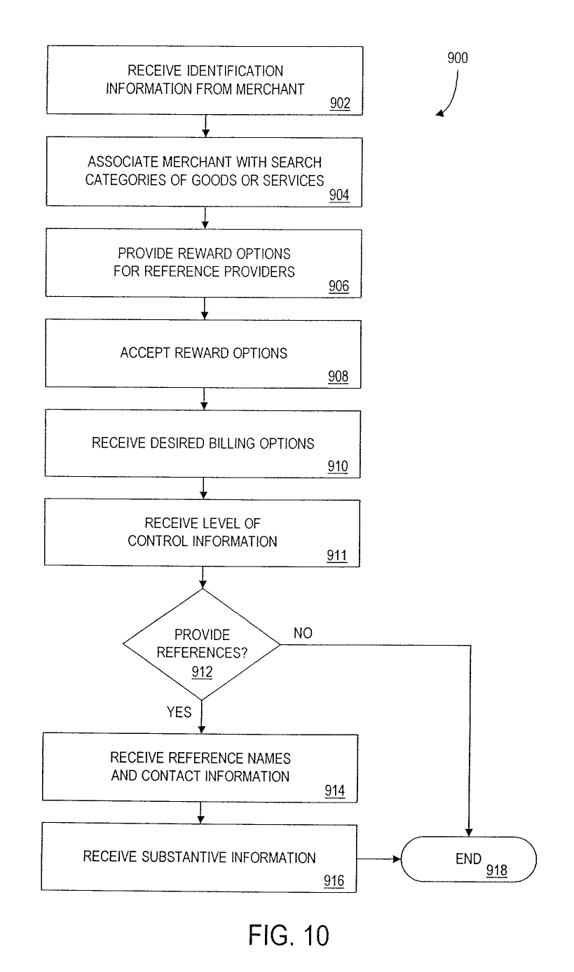

FIG. 10 is a detailed flow chart 900 illustrating exemplary processes that may be followed by the controller 200 for the registration of a merchant, as depicted by numeral 52 in FIG. 9. The registration procedure may occur via the Internet through a Web site operated by the controller 200, through a telephone system with IVR and/or touch-tone recognition, through paper processing, or through any other method known to those skilled in the art. Merchants may be solicited through advertising, direct mailing, Yellow Pages, or through referrals.

During registration of a merchant, the controller 200 receives identification information from the merchant (step 902). This information regarding the merchant may include the information depicted in the merchant database 300 of FIG. 4, such as the merchant name 304, merchant contacts 308 and contact information 310, and skills or goods 318. The merchant may then be associated with search categories of goods or services (step 904) such that a user of the method and system of the invention may quickly search for merchants. In one embodiment, the merchant could select categories from a list or tree structure of categories provided on a Web page. For example, a tax attorney could select from an attorney category and then from a tax subcategory such that a tree structure index may be used to search for merchants. In one embodiment, a separate tree structure (such as a tax category and tax attorney subcategory) could be used to reach the same subcategory. A merchant could also list itself in more than one category.

FIG. 10 next depicts that the merchant may be provided with methods by which to reward reference providers (step 906) for the merchant. The merchant may select reward methods, and the controller 200 may accept such reward methods from the merchant (step 908). When choosing methods by which to reward reference providers, the merchant may be allowed to choose the amount of money to be paid for certain types of references. For example, the merchant may pay $1.00 to a reference provider for each telephone call or e-mail communication between the reference provider and a prospective customer. In addition, the merchant may pay $0.50 to the reference provider each time a static testimonial (e.g., in audio or written form) of the reference provider is used by a prospective customer. In a further embodiment, the merchant may pay $0.25 per minute to the reference provider for telephone or instant messaging communication between reference providers and prospective customers. In building the compensation scheme, in one embodiment, merchants may be given a wide degree of latitude in choosing how to compensate reference providers. Merchants may choose to specify that compensation be provided in the form of a monetary donation to a nonprofit organization on the reference provider's behalf for each reference provided. In another embodiment, the reference provider may be compensated by being registered in a sweepstakes. In other embodiments, reference providers may choose their own rewards from available options. In still other embodiments, rewards for reference providers may be set by the system and method of the invention such that a merchant has little control over the rewards.

The controller 200 may receive desired billing options from merchants (step 910) as part of the registration process. For example, a merchant may be allowed to choose to be billed by traditional mail, e-mail or other electronic billing systems, or automated charges to credit cards or deductions from bank accounts. In addition, a merchant could choose the periods in which to be billed, such as once per month or once per calendar quarter.

In some embodiments of the invention, merchants may be allowed to exercise a level of control over the use of references, such as specifying limits on the compensation the merchant is willing to spend on references. For example, the merchant database 300 of FIG. 4 depicts a field for monthly compensation threshold 320 that may be the maximum amount of compensation that the merchant is willing to spend on all its reference providers in a given time period, such as a month. A merchant may therefore enter an amount of money that it does not wish to exceed in expenditures on references per month, and the controller 200 of the invention may receive such a threshold into storage along with other information related to the reward options, compensation schemes, and level of control over references by merchants (step 911 of FIG. 10). In addition, the controller 200 may receive from the merchant a maximum expenditure that the merchant is willing to make for each prospective customer 322 (FIG. 4) and a maximum amount of money to be spent per month on each reference or reference provider 324 (FIG. 4). By exercising a level of control over the use of references, a merchant is able to limit total expenditures, expenditures per prospective customer, and compensation to individual reference providers, and the merchant may be able to prevent gaming of the system by reference providers who may seek unjustifiable levels of compensation.

During the merchant registration process, a merchant may be allowed to specify a variety of information regarding references and reference providers (step 912 of FIG. 10). In other embodiments, merchants may not provide either names or other information regarding reference providers. In an embodiment in which a merchant desires to enter information for one or more reference provider, the controller 200 may receive reference provider names and contact information (step 914) from the merchant. A merchant may also be allowed to enter information concerning the reference provider's desired contact method, such as whether the reference provider will interact with prospective customers via e-mail, instant messaging, or telephone, or whether the reference provider wishes to provide only static testimonials. In addition, the merchant may be allowed to enter the number of contacts per time period (e.g., week, month, or year) with which the reference provider is comfortable. As shown for entry 430 in the reference provider database 400 of FIG. 5, reference provider RP3295 may wish to be contacted by initial emails from prospective customers a maximum of six times per month, along with a maximum of two follow-up e-mails per month. In addition, entry 430 indicates that reference provider RP3295 may wish to participate in a maximum of sixty minutes of instant messaging and zero minutes of telephone conversations per month, and such information may be entered on the reference provider's behalf by a merchant.

In other embodiments, the controller 200 may receive from the merchant substantive reference information (step 916) entered on the reference provider's behalf, such as the information listed in the reference database 500 of FIGS. 6A and 6B. For example, the merchant may be allowed to fill in a rating for the merchant itself (such as one to five on a quality scale) on the reference provider's behalf. The merchant may also provide a static testimonial of the reference provider's experience with the merchant. By allowing a merchant to provide information on reference providers and references, a merchant is allowed a certain degree of control over the substance of the communication between prospective customers and reference providers. In other embodiments, merchants may not be allowed to enter substantive reference information on behalf of reference providers.

Merchants may be able to provide additional information to be used by the method and system of the invention, including links to Web sites operated by the merchant, advertising information for the merchant, specifics regarding the goods or services provided by the merchant (e.g., brands of devices serviced, distances willing to travel), and audio, visual, or written messages concerning the merchant. Merchants may also provide the names of other merchants, including competitors and/or merchants involved in similar businesses in different geographical areas, and provide contact information for the merchants so that those merchants may be invited to join the service. FIG. 10 depicts one embodiment of the registration process for merchants, and it should be noted that any variety of procedures known to those skilled in the art may be used for the registration of merchants.

As an example of a merchant registration process, an optometrist who wishes to register as a merchant with the controller 200 may access a Web site on the World Wide Web for merchant registration. The controller 200 may then receive the name, address, and contact information of the optometrist, and the controller 200 may receive from the optometrist the types and categories of services offered. For example, entry 330 in the merchant database 300 of FIG. 4 depicts a merchant who has entered the merchant name “For Eyes Optometry” along with “Michael Ramon” as a contact. The controller 200 may provide a Web page offering options to the optometrist for rewarding reference providers, such as donations to nonprofit organizations, and the controller 200 may receive the optometrist's reward options. The controller 200 may then receive desired billing options from the optometrist. For instance, the optometrist may elect to have a credit card billed each month for reference provider expenses. The controller 200 may receive level of control information from the optometrist. For instance, the optometrist in entry 330 of FIG. 4 has specified that a maximum of $50 per month may be spent rewarding reference providers, a maximum of $10 may be spent on a single prospective customer, and a maximum $20 per month may be spent on a single reference provider. The optometrist may then wish to specify the identities of possible reference providers so that those possible reference providers may later choose to become reference providers for the optometrist. The controller 200 may also receive substantive reference information from the optometrist on behalf of one or more reference providers. For instance, the optometrist may specify a proposed rating for the quality of the optometrist's services on behalf of the reference provider.

### 2. Reference Registration

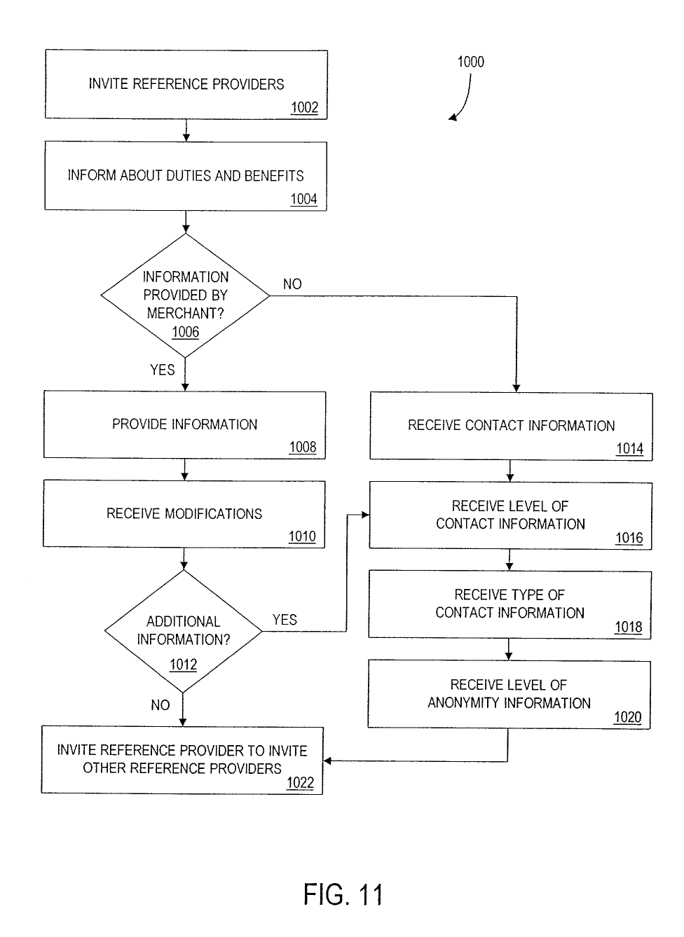

FIG. 11 is a detailed flow chart 1000 illustrating exemplary processes that may be followed by the controller 200 for the registration of a reference provider, as depicted by numeral 54 in FIG. 9. The registration procedure may occur via the Internet through a Web site operated by the controller 200, through a telephone system with IVR and/or touch-tone recognition, through paper processing, or through any other method known to those skilled in the art.

Reference providers may be invited (step 1002) to register as reference providers through a number of procedures, including the use of e-mails, direct mailings, telephone solicitations initiated by the controller 200, or invitations received from merchants registered with the system and method of the invention. The reference provider is provided with information about duties and benefits of participation as a reference (step 1004). Duties may include a minimum participation threshold (such as communicating via telephone or e-mail with a prospective customer at least once per month), availability requirements (such as being available at least one afternoon per week for communication), and obligations in providing a reference. In one embodiment, the duties of a reference provider may be specified by the merchant. Benefits may include compensation to the reference provider or to a nonprofit organization on the reference provider's behalf to entice the person or entity to serve as a reference provider. In one embodiment, the reference provider may be allowed to choose from different compensation schemes.

The controller 200 may determine whether information has been provided on a reference provider's behalf by a merchant (step 1006). If a merchant has provided information on a reference provider's behalf, the information may be provided to the reference provider (step 1008), and the controller 200 may accept modifications (step 1010) from the reference provider. Such modifications may include changes in contact information for the reference provider, rating information, testimonial information, or other substantive information about a reference. For example, the reference provider may change a quality rating that was previously entered by a merchant from five, the highest rating, to three, an average rating. In another embodiment, the reference provider could change a static, written testimonial that was previously entered by a merchant on the reference provider's behalf. The controller 200 may also query whether the reference provider wishes to enter additional information (step 1012), and other information may be accepted by the controller 200, such as level of contact information (step 1016), contact information (step 1018), and level of anonymity information (step 1020). Level of contact information may include the amount of time the reference provider is willing to spend on the telephone or instant messaging with prospective customers and the number of communications via telephone, e-mail, or instant messaging that a reference provider is willing to participate in. Level of anonymity information may include whether the reference provider is willing to provide his/her real name, address, telephone, or whether the reference provider would prefer to use an alias.

In an embodiment in which a merchant cannot provide substantive information on behalf of a reference provider, if a merchant has not provided information on behalf of a reference provider or if a merchant has provided incomplete information, the controller 200 may receive contact information (step 1014) and other substantive information from the reference provider. The level of contact information (step 1016) may include information about how often the reference provider wishes to be contacted in terms of the number of contacts and/or time spent in communication (numerals 410, 412, 414, and 416 in the reference provider database 400 of FIG. 4), the types of communication the reference provider will accept (step 1018), and the level of anonymity the reference provider wishes to keep 1020. Level of anonymity information may include data indicating that the reference provider wishes to have e-mail communication be anonymous or that the reference provider wishes to have voices be altered during telephone conversations. A reference provider, for example, may wish to use an alias for a name, withhold address information, and withhold occupation information.

In one embodiment, a reference provider may set up individual references, such as those depicted in the reference database 500 of FIGS. 6A and 6B. It should be noted that the level of contact information 1016, type of contact 1018, and level of anonymity information 1020 may be received in individual references rather than as basic information on behalf of the reference provider. For example, a single reference provider may set up five references, perhaps for a plurality of different merchants, and the reference provider may specify different levels of contact, types of communication, and levels of anonymity for each reference. FIGS. 6A and 6B depict references 530 and 532, each of which is made by reference provider RP8562, and different contact and availability information is provided for each reference. In one embodiment, by filling in information for a particular reference, such as the fields shown in FIGS. 6A and 6B, a reference provider can control its amount of activity with prospective customers.

After the controller 200 has received reference provider and reference information, the reference provider may be invited to invite other reference providers to provide references for merchants (step 1022).

As an example of a reference provider registration procedure, an accountant may define an individual as a possible reference provider for the accountant. The possible reference provider may be informed about the duties and benefits of becoming a reference provider through e-mail notification from the controller 200. The reference provider may specify contact information and payment rules for rewards for acting as a reference provider. The reference provider may then decide to complete a reference for the accountant, and the reference provider may fill out an entry for a reference such as that depicted by entry 530 in the reference database 500 of FIGS. 6A and 6B. For instance, the reference provider, RP8562, may provide a rating, testimonial, and audio clip as shown in FIG. 6A, and reference provider RP8562 may also accept communication by phone or instant messaging, as shown in field 510 for entry 530 in FIG. 6A. In addition, reference provider RP8562 may specify the times that he/she is available for communication by phone or instant messaging. Reference provider RP8562 may indicate that he/she is willing to spend 30 minutes in instant messaging communication per month for the reference and 30 minutes in telephone communication for the reference per month. After completion of the reference for the accountant, reference provider RP8562 may complete a reference for a different merchant.

### 3. Search for Merchants

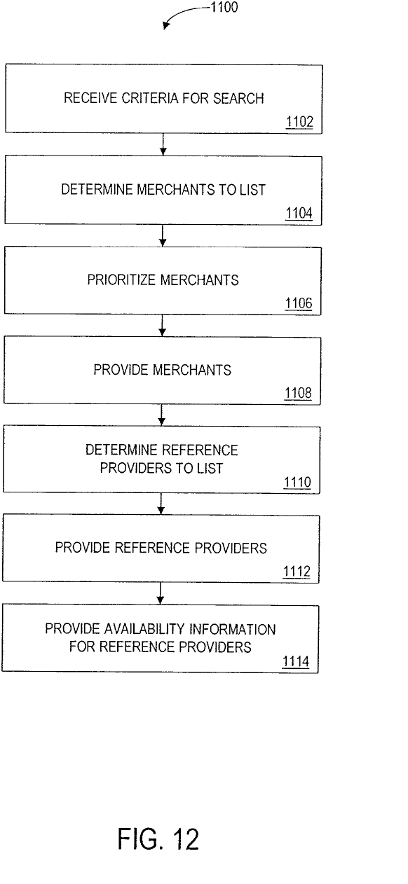

FIG. 12 is a flow chart 1100 depicting one embodiment of the actions carried out by the controller 200 during a search for merchants by a prospective customer. FIG. 12 shows in greater detail the acts of accepting search criteria 56, providing merchant information 58, and providing reference provider information 60 depicted in FIG. 9. Referring to FIG. 12, search criteria is received by the controller 200 in act 1102. The controller 200 can provide numerous options that may be used by prospective customers in order to search for merchants. In one embodiment, a prospective customer can specify the type of service or merchant desired (e.g., a plumber, an electrician, a shoe dealer), the name of a merchant, geographical area of a merchant, area code or zip code of a merchant, or any other type of information concerning a merchant or the goods or services of a merchant. Merchants matching the criteria may be returned by the controller 200. Any number of types of criteria, including a single criterion, may be used for searching for merchants. In a related embodiment, a prospective customer can choose merchants from lists of services or types of goods. Such lists may be in a menu form in a Web page for an Internet embodiment, oral for a telephone, touchpad, or voice recognition embodiment, or in any other form known to those skilled in the art. A tree-search type menu that categorizes merchants may be presented to the prospective customer so that the prospective customer may choose a desired merchant.

A prospective customer may also be able to search for merchants by reference information. For example, a prospective customer may search for plumbers in a given city or geographical area with at least two references available, with certain quality ratings in terms of cost, timeliness, or other features, or with an overall rating by reference providers as excellent. In such an embodiment, the controller 200 may search through the merchant and reference records for fitting merchants.

In another embodiment allowing a prospective customer to search for merchants, a prospective customer may be allowed to enter specific requirements for what the prospective customer wants, such as a skylight for under $2,000, and the controller 200 may search for and provide merchants willing to meet those requirements. The specific requirements of the prospective customer may be embodied in a request for proposal that may be submitted to multiple merchants so that those merchants may make a proposal to fulfill the request. In yet another embodiment, a prospective customer may be allowed to specify a query for a need that the prospective customer wishes to be fulfilled. The controller 200 may recognize keywords in the query and search for merchants or, in other embodiments, a person may review the query and then provide matching merchants.

Referring again to FIG. 12, after search criteria for merchants has been received, the controller 200 determines the merchants to provide in response to the prospective customer's query (step 1104). In another embodiment, only merchants with available, active reference providers may be provided. An “active reference provider” may be a reference provider that is available for contact based on the control exercised by the reference providers and/or merchants. For instance, in one embodiment, a reference provider who has been contacted the maximum number of times allowed by the reference provider in the time period will not be available as an active reference provider. In yet another embodiment, only merchants with available compensation finds for reference providers may be provided to the prospective customer. In still other embodiments, all merchants matching the search criteria may be provided, including merchants with no active reference providers and merchants that are not registered with the system and method of the invention. Merchants are provided to prospective customers at act 1108 of FIG. 12. Merchants may be listed on a Web page in any manner known to those skilled in the art or merchants may be provided orally in a telephone embodiment of the invention.

In one embodiment, the merchants provided to the prospective customer may be prioritized such that they are presented to the prospective customer in a certain order (step 1106). Such an order may be determined based on the usage of certain merchants compared to other merchants that are found in the search. For example, a merchant that has not been used by any prospective customers may, in one embodiment, be listed or provided to the prospective customer before a merchant that has been used. In other embodiments, merchants that are willing to spend a large amount of money rewarding reference providers may be listed or provided to the prospective customer before merchants that are willing to spend a small amount of money. In still other embodiments, merchants may be listed according to the number of reference providers available for each merchant. Any other prioritizing scheme known to those skilled in the art may also be used within the scope of the invention.

The merchants may be provided to the prospective customers by the controller 200 in any method known to those skilled in the art. In an Internet embodiment, a list of one or more merchants may be provided, whereas in a telephone embodiment, merchants may be provided in audio form. In addition, merchant information, such as the merchant's identity and detailed information about the capabilities of the merchant, may be provided to the prospective customers. Such merchant information may include the number of reference providers available for the merchant, the average rating of the merchant by reference providers, and/or the address of the merchant.

Reference provider information may also be provided to the prospective customer (step 1112) by the controller 200. Before providing reference providers, a determination of the reference providers to list and/or the order in which to list reference providers may be made (step 1110). In one embodiment, the merchant may have some control over the order in which to provide reference providers to the prospective customer. For instance, the merchant may choose to list certain reference providers before other reference providers based on the cost to the merchant for use of the reference providers, the overall usage rate of reference providers, occupations, incomes or geographic locations of the reference providers, or based on any other scheme desired by the merchant (e.g., personal knowledge of the reference provider). In this manner, reference providers may be categorized. In addition, reference data for reference providers, such as any of the data above, may be presented to prospective customers by the controller 200.

Reference provider information may be provided or displayed to a prospective customer in any manner known to those skilled in the art. In one embodiment, such information may be displayed on a Web page along with the merchant information. In other embodiments, a prospective customer could select one or more merchants to view or hear reference provider information for the merchant(s). In still other embodiments, the prospective customer could select a merchant to view more detailed information about the merchant, and a selection could be made available for viewing of reference providers for the merchant. The timing, order, and organization in which the reference provider information and merchant information are provided to the prospective customer are not meant to limit the scope of the invention. Availability information for reference providers may also be provided to the merchants (step 1114). In one embodiment, for instance, the times at which the reference provider is available for instant messaging or telephone communication may be listed. In other embodiments, only those reference providers that are available for communication at the time of the search by the prospective customer may be listed. For instance, in one embodiment, only those reference providers who indicate that they are available for communication at the time of the search of the prospective customer may be listed. In yet other embodiments, the modes of communication available for given reference providers may be displayed in icon form, such as an icon for e-mail communication, telephone communication, or instant messaging communication. In one embodiment, the icons for modes of communication may only be presented if the timing of the communication is acceptable to the reference provider. For instance, an instant messaging icon may be displayed for a reference provider if the controller 200 determines that the reference provider is online and available at the time of the search by the prospective customer.

As an example of the process 1100 of FIG. 12, a prospective customer may wish to locate a plumber for residential buildings in the Chicago area. In an Internet embodiment, the prospective customer could enter search criteria, such as “Chicago plumber,” into a search field on a Web page. The controller 200 could then search through the merchant database300 and determine the merchants that match the search criteria, i.e., merchants that are plumbers in the Chicago area. The order in which to list the plumbers may be determined by the controller 200, such that the plumber with the most reference providers or the plumber with the largest amount of available reward money for reference providers is listed first. The list of plumbers is then provided to the prospective customer. In one embodiment, the prospective customer could see the name, location, and rating of each plumber on a Web page. After a list of plumbers is presented to the prospective customer, the prospective customer could select a particular plumber and view more detailed information about the plumber and/or view reference providers who are willing to provide a reference for the plumber. In one embodiment, the controller 200 may determine the reference providers to provide to the prospective customer, such that only active reference providers or reference providers who live in the same zip code as the prospective customer are provided. Availability information, such as the times a reference provider is available for telephone communication and/or the types of references the reference provide is willing to supply may be provided to the prospective customer.

### 4. Control of Contact Between a Prospective Customer and a Reference Provider

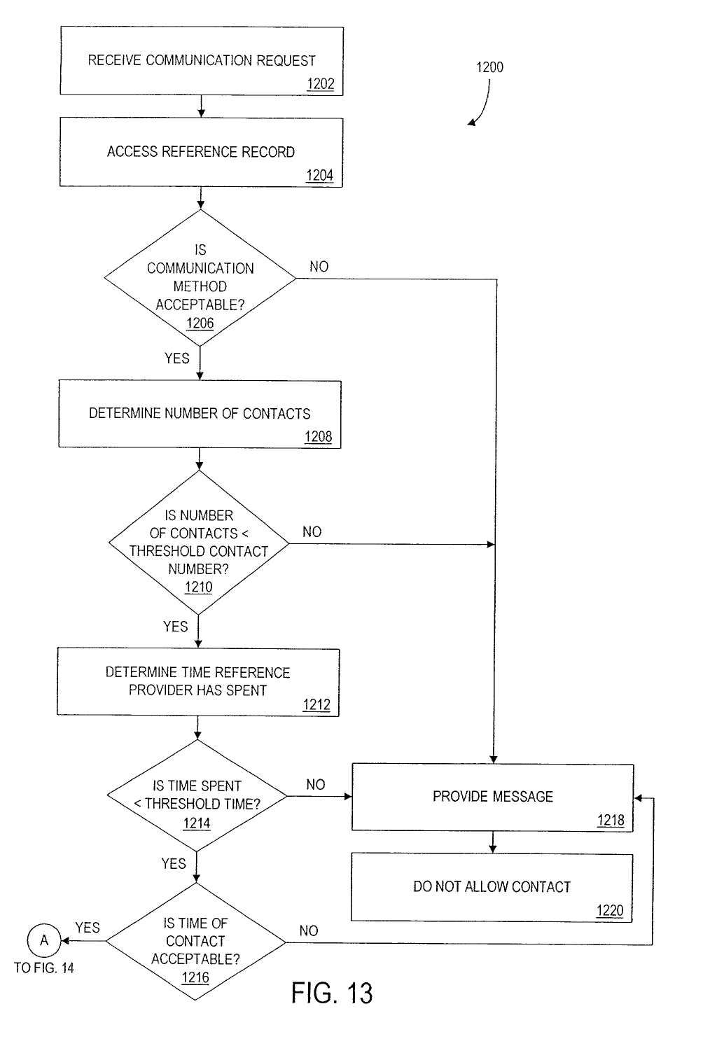

FIG. 13 depicts a flow chart 1200 that illustrates the actions of the controller 200 that provide a reference provider with control over communication with prospective customers. As part of the act of facilitating communication between a prospective customer and a reference provider 62 as depicted in FIG. 9, the reference provider and/or the merchant may control the type of communication and/or timing of the communication. The controller 200 receives a request to communicate with a reference provider (step 1202) and accesses the corresponding reference record (step 1204), such as one of the records illustrated in the reference database 500 of FIG. 6. Although FIG. 13 is illustrated beginning with the act of receiving a communication request (step 1202), it should be noted that the logic depicted in FIG. 13 may be performed before reference providers or references are provided to a prospective customer, such that only available reference providers may be provided to prospective customers. For example, the controller 200 may determine if the method of communication requested by a prospective customer is acceptable (e.g., in terms of the methods of communication allowed by the reference provider) at act 1206. In one embodiment, the reference record (FIG. 6) lists the availability of the reference provider (availability 512), and hence only communication methods accepted by the reference provider may be available for selection by a prospective customer in the first instance. For example, record 532 in FIG. 6A specifies that reference R0004 is a rating for merchant SP6385 and that reference provider RP8562 does not participate in any type of communication with prospective customers for that reference. In one embodiment, no communication options would be provided to a prospective customer for reference R0004 because the reference provider does not accept communication.

If the communication method is not acceptable, an appropriate message may be provided to the prospective customer (step 1218) in an embodiment in which the prospective customer is allowed to attempt to initiate any manner of communication. If the communication method is acceptable, the total number of contacts made with the reference provider in the given time period and the total number of follow-up communications made with the reference provider may be determined (step 1208). If the total number of contacts is less than the threshold number of contacts (e.g., numerals 516 and/or 518 of FIG. 6), then the reference provider may be willing to accept contact. If the threshold number of contacts has been reached, an appropriate message may be displayed to the prospective customer (step 1218) and the contact may not be allowed (step 1220). For example, record 520 in FIG. 6B indicates that 6 initial e-mail communications per month are allowed for reference R0001 by reference provider RP3592. By reviewing the contact database 700 of FIG. 8, it could be determined that RP3592 has already had 4 initial e-mail communications in the month. Because the actual number of initial e-mails, 4, is less than the threshold number of e-mails, 6, the reference provider may be willing to accept the communication.

If the total number of contacts is less than the threshold number of contacts, the total amount of time the reference provider has spent in communication with prospective customers in the given time period may be determined (step 1212). If the total amount of time spent is less than the threshold time (numerals 520 and/or 522 of FIG. 6), then the reference provider still has contact time available and the contact may be allowed. If the threshold time has been met (determined at act 1214 of FIG. 13), then an appropriate message may be provided (step 1218) to the prospective customer and the contact may not be allowed (step 1220). Such a message may include a prompt to attempt contact with a different reference provider or to attempt contact with the same reference provider at a different time. For example, record 522 of FIG. 6B indicates that reference provider RP3295 has 60 minutes of telephone discussion time available in a given month for reference R0002. The contact database 700 of FIG. 8 may be reviewed to determine that reference provider RP3295 has spent 20 minutes in telephone discussions in the month, and hence reference provider RP3295 has available contact time left for communication.

If the reference provider has contact time available, the timing of the contact may be evaluated to determine if it is acceptable to the reference provider (step 1216). If the timing is not acceptable, an appropriate message may be provided (step 1218) to the prospective customer and the contact may not be allowed (step 1220). If the timing is acceptable, then the contact is acceptable to the reference provider, and the contact may be allowed if the contact is acceptable to the merchant. For example, reference provider RP3595 is available for telephone contact each Tuesday from 5pm until 6pm for reference R0002. If a communication request is made for that time period, communication may be facilitated. In another embodiment, after a telephone communication has been requested, the controller 200 could place a call to the reference provider and, if the reference provider answers the call, a call could be placed to the prospective customer to facilitate communication.

Those skilled in the art will recognize that various modifications may be made in the manner of the processing depicted in FIG. 13 without departing from the scope of the invention. By evaluating information provided by a reference provider at some time before contact with the reference provider is made, a level of control by the reference provider over contacts with prospective customers may be provided.

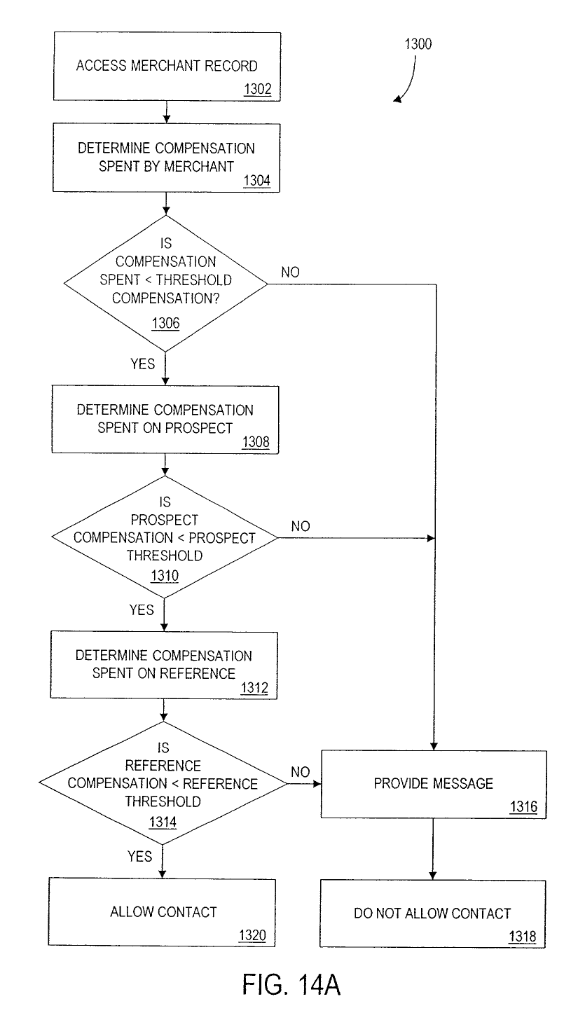

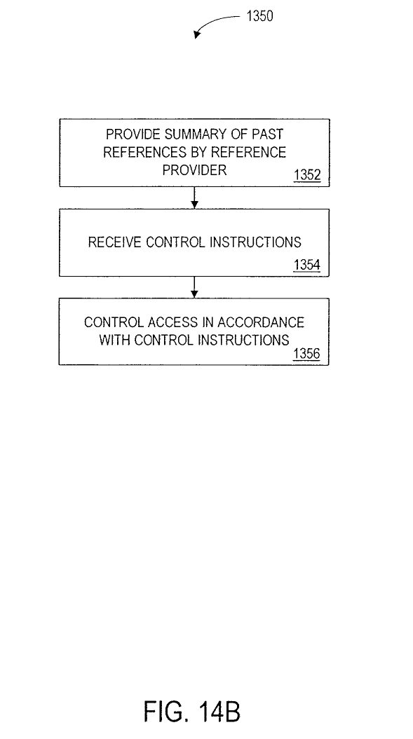

FIG. 14A depicts a flow chart 1300 that illustrates the actions of the controller 200 that provide a merchant with control over communication with prospective customers in one embodiment of the invention. The controller 200 receives a request to communicate with a reference provider and accesses the corresponding merchant record (step 1204), such as one of the records illustrated in merchant database 300 of FIG. 4. Although FIG. 14A is illustrated beginning from the standpoint that a determination of availability is made after communication requests, it should be noted that the logic depicted in FIG. 14A may be performed before reference providers or references are provided to a prospective customer. For example, in one embodiment, only references and reference providers for which the merchant will allow communication may be provided to the prospective customers so that the logic of FIG. 14A may be performed before a communication request has been received from a prospective customer.

At act 1304, the total compensation spent by the merchant may be determined. In one embodiment, this total compensation may be determined by adding the total communication time and number of communications for a given merchant from the contact database 700 illustrated in FIG. 8, and determining the compensation spent from these numbers. If the compensation spent is less than the threshold compensation (numeral 320 of FIG. 4) the merchant is willing to spend (step 1306), communication may be allowed. If the compensation is greater than or equal to the threshold, an appropriate message may be displayed to the prospective customer (step 1316) and the contact may not be allowed (step 1318). For example, merchant SP2532 of entry 330 in FIG. 4 has a compensation threshold 320 of $50 per month. If merchant SP2532 has only spent $45 in the month before the request for communication, the communication may be allowed.

If the merchant's compensation threshold has not been met, the total compensation already spent on the prospective customer requesting the communication may be determined (step 1308). For example, a prospective customer may have communicated with other reference providers and the merchant may have already spent some money on that prospective customer. If the total amount spent on the prospective customer (step 1310) is less than the maximum expenditure per prospective customer (numeral 322 of FIG. 4), then the contact may be allowed. If the total amount spent on the prospective customer is equal to or greater than the maximum expenditure per prospective customer, an appropriate message may be displayed to the prospective customer (step 1316) and the contact may not be allowed (step 1318). For example, merchant SP2532 in entry 330 in the merchant database 300 of FIG. 4 lists a maximum expenditure per prospect 322 of $10. If $10 has already been spent on a prospective customer by merchant SP2532, then communication may not be allowed in response to a communication request.

If the total amount spent on the prospective customer (step 1310) is less than the maximum expenditure per prospective customer, the total compensation spent by the merchant on the reference provider or on the particular reference may be determined (step 1312). This expenditure on the reference or reference provider may then be compared (step 1314) with the maximum expenditure per reference or reference provider that the merchant will allow (numeral 324 of FIG. 4). If the total amount spent on the reference or reference provider is greater than or equal to the maximum expenditure per reference or reference provider, an appropriate message may be displayed to the prospective customer (step 1316) and the contact may not be allowed (step 1318). If the total amount spent on the reference or reference provider is less than the maximum expenditure per reference or reference provider, the contact may be allowed (step 1320). For example, merchant SP2532 lists a maximum expenditure per reference 324 of $20 in entry 330 of the merchant database 300 of FIG. 4. If only $10 has already been spent on a given reference for merchant SP2532, then communication may be allowed in response to a communication request.

A merchant may also control communication so that only certain types or methods of communication may be allowed (e.g., e-mail, instant messaging). Those skilled in the art will recognize that various modifications may be made to the manner and order of the processing depicted in FIG. 14A without departing from the scope of the invention. By evaluating information provided by a merchant at some time before contact between the prospective customer and the reference provider is initiated, a level of control by the merchant over contacts may be provided.

FIG. 14B is a flow diagram 1350 of another embodiment of the invention that provides a merchant with control over communication between reference providers and prospective customers. FIG. 14B depicts a flow chart 1350 of an embodiment of the invention that may be used to provide ongoing control over references by a merchant during operation of the method and system of the invention. In the embodiment of FIG. 14B, a merchant is provided with a summary of past references provided by at least one reference provider for the merchant (step 1352). Such a summary may be provided to the merchant in any manner known to those skilled in the art. In one embodiment, a list of all reference providers who have provided references for the merchant may be displayed, and the list may contain the number of communications made with each reference provider and the compensation spent on the reference provider in a given time period.

After accessing the summary of references provided, the merchant can provide control instructions to the controller and the controller 200 may receive the control instructions from the merchant (step 1354). The control instructions may be any type of instructions that provide the merchant with a level of control over a reference provider. In one embodiment, the merchant may access the summary for a reference provider and view or listen to the reference provided by the reference provider. For example, the merchant could, in one embodiment, view the e-mail correspondence between a reference provider and a prospective customer. In an Internet embodiment, a Web page displaying one or more options for controlling access to the reference provider may be displayed to the merchant. For instance, one option may be for the merchant to deactivate the reference provider so that the particular reference provider will no longer be available to provide references for the merchant when prospective customer searches locate the merchant in the future. In another embodiment, an option may be to limit the references provided by the reference provider to a certain number of communications or time for communication. In yet another embodiment, an option for control instructions may be to communicate (via e-mail, telephone, or instant messaging) with the reference provider to determine why the reference provider provided a particular reference or why the reference provider has communicated a lot with one or more prospective customers. Other types of control instructions may include limiting further access to a reference provider by a particular prospective customer, limiting compensation to a particular reference provider, or flagging a reference provider for monitoring so that the merchant will be notified when the reference provider communicates with a prospective customer in the future.

The controller 200 may control the access to the reference provider in accordance with the control instructions (step 1356). For instance, if a merchant deactivates a reference provider, that reference provider may no longer be available for communication with prospective customers. In another embodiment, a reduced number of communications or communication time may be available for the reference provider in accordance with the control instructions. The controller 200 may, therefore, limit access or control access to the reference provider in accordance with the control instructions. The processes depicted in FIGS. 14A and 14B provide the merchant with control over reference providers for the merchant. In addition, a merchant may control a reference provider by being able provide an indication that a certain reference provider will not be allowed to provide a reference for the merchant.

### 5. Communication Between Prospective Customers and Reference Providers

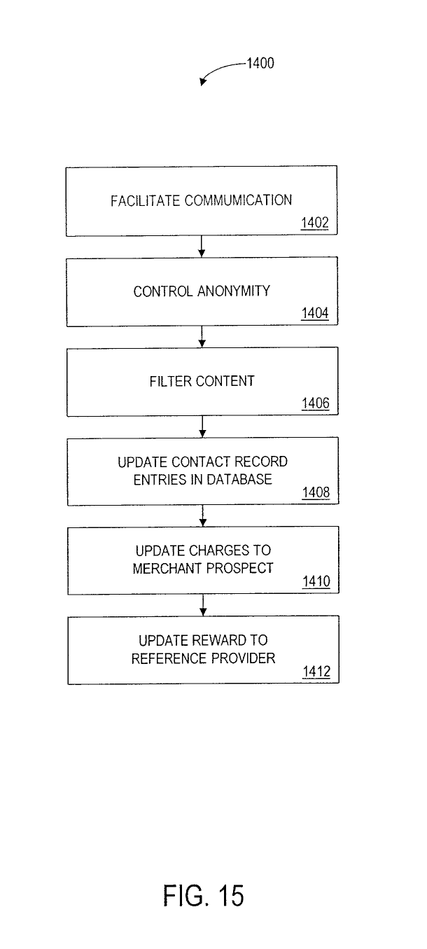

FIG. 15 depicts a flow chart 1400 of one embodiment of the process performed by the controller 200 when a reference provider communicates with a prospective customer. FIG. 15 provides further details regarding the act of facilitating communication between a prospective customer and a reference provider 62 of FIG. 9. At act 1402 of FIG. 15, communication between a prospective customer and a reference provider may be facilitated by the controller 200. Such communication may take place via telephone, instant messaging, email, video conferencing, or any other type of communication known to those skilled in the art. In one embodiment, the anonymity of the reference provider and possibly of the prospective customer may be controlled (step 1404). For instance, the controller 200 may assign each party unique, anonymous e-mail addresses or voices may be masked or altered for telephone conversations. In such ways, the anonymity of the parties may be preserved. Communication may be instantaneous (e.g., telephone or instant messaging) or time delayed (e.g., e-mail). For instantaneous on-line communication, the reference provider may specify a maximum amount of time for communication, and communication between the prospective customer and the reference provider may be terminated after that maximum amount of time.

In order to preserve the anonymity of the reference provider and the prospective customer during telephone communication, the controller 200 may place the call to both parties. Each party, therefore, may not have access to the name or telephone number of the other party. In such a manner, anonymity of the reference provider and the prospective customer could be preserved.

In one embodiment, a reference provider may provide a reference without interactively communicating with a prospective customer. Instead, the prospective customer may access a written or audio testimonial or evaluation of the merchant by the reference provider. The communication between the reference provider and the prospective customer, therefore, is not interactive, but instead consists of the prospective customer accessing and listening to or reading a static testimonial or evaluation.

In one embodiment, communication between prospective customers and reference providers may be facilitated through the use of questionnaires. A questionnaire form may be provided to a prospective customer when a prospective customer selects an option to communicate with the reference provider through the use of a questionnaire. The controller 200 may then accept instructions from the prospective customer to customize the questionnaire form to meet the specific inquiries of the prospective customer. In one embodiment, this may be performed by allowing the prospective customer to enter specific questions. The merchant and/or the reference provider could also customize the questionnaire form by: (1) specifying a maximum number of questions; (2) specifying a maximum length of the questions; (3) specifying the type of question, such as Yes/No or scale from 1 to 5; or (4) specifying default questions that may be customized by the prospective customer. The customized questionnaire form may then be delivered to the reference provider. E-mail, voice messaging, or any other type of questionnaire known to those skilled in the art may be used. The reference provider may then complete the questionnaire and the controller 200 may receive the completed questionnaire from the reference provider and deliver it to the prospective customer.

Other methods may also be used to facilitate communication between prospective customers and reference providers. For instance, communication may be facilitated by accepting audio, video, or e-mail queries from prospective customers, delivering the queries to reference providers, and delivering responses from the reference providers to the prospective customers.

During communication, the controller 200 may filter content (step 1406). In one embodiment, for example, a database of frequently asked questions may be maintained. If a prospective customer sends an e-mail, the e-mail may be reviewed for keywords, and it may be determined that a commonly asked question has been asked, such as the times a merchant store is open. In such a case, an answer may be automatically sent to the prospective customer and the merchant, in one embodiment, may not have to pay for the communication. In this way, communications may be monitored so that merchants pay only for more meaningful questions or pay a reduced rate for certain questions. Certain purely factual questions about the merchant may be better answered by the merchant than by a reference provider. Filtering communication, therefore, may allow purely factual questions to be answered by reference to a fact sheet about the merchant, while allowing reference providers to provide more subjective evaluations of the quality of the merchant.

After communication has been consummated, the contact database may be updated to reflect the contact (step 1408). Referring now to FIG. 8, a new entry may be added in the contact database 700 to reflect that a contact has been completed. In addition, in one embodiment, the prospective customer database 600 of FIG. 7 may be updated if the prospective customer has not used the system in the past. A new entry in FIG. 7 may be completed to reflect the use by the prospective customer.

Referring again to FIG. 15, charges to merchants and/or merchants may be posted when communication is consummated (step 1410). Merchants may be charged based on the duration of the contact, type of contact, and based on whether the contact is an initial contact or a follow-up contact. In one embodiment, a reference provider may not be able to answer a prospective customer's inquiry. In such a case, the reference provider may provide a response message indicating an inability to answer the inquiry, and the merchant may not be charged for the communication. In another embodiment, prospective customers may also be charged for communication with reference providers. In one embodiment, one charge rate may be applicable for access to a static written reference, a second charge rate (per contact and/or minute) may be applicable for access to a static telephonic reference check, a third rate may be applicable to e-mail communications, a fourth rate (per minute and/or contact) may be applicable to dynamic telephonic references, and a fifth rate (per minute and/or contact) may be applicable for instant messaging references. In one embodiment, a merchant could be charged only once for a set number of e-mail reference checks. For instance, three rounds of e-mails may be considered a single communication for purposes of charging a merchant for the communication. In this manner, a prospective customer may be allowed a considerable amount of interactive communication with a reference provider without duplicative charges.

In one embodiment, a portion or all of the charges to the merchant or prospective customer for communication with a reference provider may be used to reward the reference provider (step 1412). The reward to the reference provider may come in the form of monetary compensation, reduced purchase prices on goods or services of the merchant, or donations to nonprofit organizations on behalf of the reference provider.

After a transaction between a merchant and a prospective customer has been completed, feedback may be gathered regarding the transaction. In one embodiment, the controller 200 may receive a completed transaction indication from the merchant and contact the prospective customer who used the merchant and invite the prospective customer to provide evaluative information regarding the merchant and/or the reference provider. This may be accomplished by providing a usage questionnaire to the prospective customer and receiving a completed usage questionnaire. In one embodiment, a series of questions may elicit written responses. In another embodiment, a testimonial may be elicited from a prospective customer. In this manner, additional information about merchants may be collected, and a prospective customer who has used a merchant may become a reference provider for the merchant. In one embodiment, the feedback from prospective customers about merchants may be kept separate from references provided by reference providers. Thee merchant may then be given an opportunity to respond to the feedback from the customer before the feedback becomes available to other prospective customers.

Although the present invention has been described with respect to a preferred embodiment thereof, those skilled in the art will note that various substitutions may be made to those embodiments described herein without departing from the spirit and scope of the present invention.

What is claimed is:

1. A method comprising:
receiving one or more criteria from a prospective customer regarding a potential purchase;
providing merchant information for at least one merchant in response to the one or more criteria;
providing at least one reference provider for the at least one merchant, wherein the at least one merchant provides control instructions regarding access to the at least one reference provider; and
enabling communication between the prospective customer and the at least one reference provider.

2. The method of claim 1, wherein enabling communication comprises:
providing to the prospective customer a questionnaire form;
accepting instructions from the prospective customer to customize the questionnaire form; and
delivering the customized questionnaire form to the at least one reference provider.

3. The method of claim 2, wherein the questionnaire form is an e-mail questionnaire form.

4. The method of claim 1, wherein enabling communication comprises:
initiating one of an instant messaging session or a telephone dialogue.

5. The method of claim 1, wherein enabling communication comprises:
receiving a query from the prospective customer;
delivering the query to the at least one reference provider; and
delivering a response from the at least one reference provider to the prospective customer.

6. The method of claim 5, wherein the query is an audio query.

7. The method of claim 1, wherein enabling communication comprises:
enabling anonymous communication.

8. The method of claim 1, further comprising:
determining a reward the at least one reference provider receives for providing a reference.

9. The method of claim 1, further comprising:
categorizing the at least one reference provider.

10. The method of claim 9, wherein categorizing comprises:
categorizing by at least one of:
frequency of use,
rating,
size ofjob,
reference provider occupation, and
geographical data.

11. The method of claim 1, further comprising:
providing reference provider data for the at least one reference provider.

12. The method of claim 11, wherein the reference provider data comprises at least one of:
a number of times the at least one reference provider has been used,
an occupation of the at least one reference provider,
a usage rate of the merchant by past users of the at least one reference provider, and
an income of the at least one reference provider.

13. The method of claim 1, further comprising:
providing contact preferences for the at least one reference provider.

14. The method of claim 1, further comprising:
controlling a level of anonymity of the at least one reference provider.

15. The method of claim 1, further comprising:
providing a rating of the at least one merchant based at least partially on input from the at least one reference provider.

16. The method of claim 1, further comprising:
registering the at least one merchant.

17. The method of claim 16, wherein registering comprises:
receiving merchant information through one of a telephony service and the Internet.

18. The method of claim 16, further comprising:
providing a list of categories to the at least one merchant; and
receiving category information from the at least one merchant.

19. The method of claim 16, further comprising:
registering the at least one reference provider.

20. The method of claim 19, wherein registering the at least one merchant further comprises:
receiving reference provider information from the at least one merchant.

21. The method of claim 20, wherein registering the at least one reference provider comprises:
allowing the at least one reference provider to modify the reference provider information.

22. The method of claim 1, further comprising:
charging the at least one merchant if a reference is provided by the at least one reference provider.

23. The method of claim 1, further comprising:
providing static testimonials from the at least one reference provider.

24. The method of claim 1, further comprising:
receiving a completed transaction indication from the at least one merchant;
providing a usage questionnaire to the prospective customer; and
receiving a completed usage questionnaire from the prospective customer.

25. A method comprising:
receiving one or more criteria from a prospective customer regarding a potential purchase;
providing at least one merchant in response to the one or more criteria; and
providing at least one reference provider for the at least one merchant, wherein the at least one merchant has control over the at least one reference provider.

26. The method of claim 25, further comprising:
accessing a level of control of the at least one merchant over the at least one reference provider;
determining whether the at least one merchant is willing to allow a reference by the at least one reference provider by reviewing the level of control; and
enabling communication between the prospective customer and the at least one reference provider if the merchant is willing to allow the reference.

27. The method of claim 26, wherein determining comprises:
determining if an actual merchant expenditure is less than a maximum merchant threshold expenditure.

28. The method of claim 26, wherein determining comprises:
determining if an actual expenditure per prospective customer is less than a maximum expenditure per prospective customer.

29. The method of claim 26, wherein determining comprises:
determining if an actual expenditure per reference is less than a maximum expenditure per reference.

30. The method of claim 26, wherein determining comprises:
determining a type of communication for which the at least one merchant is willing to allow the reference, and
wherein enabling communication comprises:
allowing only the type of communication for which the at least one merchant is willing to allow the reference.

31. The method of claim 25, further comprising:
determining a reward the at least one reference provider receives for providing a reference.

32. The method of claim 25, further comprising:
receiving from the prospective customer a request to contact the at least one reference provider;
determining availability criteria associated with the at least one reference provider;
determining whether the at least one reference provider is willing to accept the request based on the availability criteria; and
enabling communication between the prospective customer and the at least one reference provider if the at least one reference provider is willing to accept the request.

33. The method of claim 32, further comprising:
receiving availability criteria for the at least one reference provider.

34. The method of claim 32, wherein the availability criteria are levels of activity with which the at least one reference provider is comfortable.

35. The method of claim 34, wherein the levels of activity are selected from the group comprising:
contact methods,
frequency of contact,
contact times, and
number of distinct prospective customers communicated with by the at least one reference provider.

36. The method of claim 25, further comprising:
controlling a level of anonymity of the at least one reference provider.

37. The method of claim 25, further comprising:
providing a rating of the at least one merchant based at least partially on input from the at least one reference provider.

38. The method of claim 25, wherein one of the one or more criteria is a desired rating based on reference provider input.

39. The method of claim 25, further comprising:
receiving from the prospective customer an inquiry message for the at least one reference provider;
delivering the inquiry message to the at least one reference provider; and
delivering a response message from the at least one reference provider to the prospective customer.

40. The method of claim 39, wherein the response message is an indication of inability to answer the inquiry message.

41. The method of claim 39 wherein the inquiry message and the response message are selected from the group comprising e-mail messages and voice recordings.

42. A method comprising:
providing one or more criteria regarding a potential purchase;
receiving merchant information for at least one merchant in response to the one or more criteria;
receiving at least one reference provider for the at least one merchant; and
communicating with the at least one reference provider to receive a reference.

43. A method comprising:
providing one or more criteria regarding a potential purchase;
receiving a list of at least one merchant in response to the one or more criteria; and
receiving a list of at least one reference provider for the at least one merchant, wherein the at least one merchant has control over the at least one reference provider.

44. A reference device, comprising:
a processor; and
a storage device coupled to said processor and storing instructions adapted to be executed by said processor to:
receive one or more criteria from a prospective customer regarding a potential service;
provide merchant information for at least one merchant in response to the one or more criteria;
provide at least one reference provider for the at least one merchant; and
enable communication between the prospective customer and the at least one reference provider.

45. The device of claim 44, wherein the storage device further stores at least one of:
a merchant database,
a reference provider database,
a reference database,
a prospective customer database, and
a contact database.

46. A reference device, comprising:
a processor; and
a storage device coupled to said processor and storing instructions adapted to be executed by said processor to:
receive one or more criteria from a prospective customer regarding a potential purchase;
provide a list of at least one merchant in response to the one or more criteria; and
provide a list of at least one reference provider for the at least one merchant, wherein the at least one merchant has control over the at least one reference provider.

47. A medium storing instructions adapted to be executed by a processor to perform a method comprising:
receiving one or more criteria from a prospective customer regarding a potential purchase;
providing merchant information for at least one merchant in response to the one or more criteria;
providing at least one reference provider for the at least one merchant; and
enabling communication between the prospective customer and the at least one reference provider.

48. A medium storing instructions adapted to be executed by a processor to perform a method comprising:
receiving one or more criteria from a prospective customer regarding a potential purchase;
providing a list of at least one merchant in response to the one or more criteria; and
providing a list of at least one reference provider for the at least one merchant, wherein the at least one merchant has control over the at least one reference provider.

49. A method comprising:
providing a summary of past references provided by at least one reference provider for a merchant;
receiving control instructions from the merchant; and
controlling access to the at least one reference provider by at least one prospective customer in accordance with the control instructions.

50. The method of claim 49, wherein the control instructions are instructions to deactivate the at least one reference provider.

51. The method of claim 50, wherein controlling access comprises:
preventing communication between the at least one reference provider and the at least one prospective customer.

52. An apparatus for providing a reference for a prospective customer, comprising:
means for receiving one or more criteria from a prospective customer regarding a potential purchase;
means for providing merchant information for at least one merchant in response to the one or more criteria;
means for providing at least one reference provider for the at least one merchant; and
means for enabling communication between the prospective customer and the at least one reference provider.
